(19) United States
(12) Patent Application Publication
(10) Pub. No.: US 2026/0056219 A1
(43) Pub. Date: Feb. 26, 2026

(54) HYBRIDIZED CONTROL ARCHITECTURE FOR VESSEL MOVER MOVEMENT CONTROL

(71) Applicant: Siemens Healthcare Diagnostics Inc., Tarrytown, NY (US)

(72) Inventors: Narayanan Ramakrishnan, New City, NY (US); Mark Edwards, Armonk, NY (US)

(73) Assignee: Siemens Healthcare Diagnostics Inc., Tarrytown, NY (US)

(21) Appl. No.: 19/105,789

(22) PCT Filed: Aug. 18, 2023
(86) PCT No.: PCT/US2023/072521

§ 371 Date: Feb. 21, 2025

Related U.S. Application Data
(60) Provisional application No. 63/373,359, filed on Aug. 24, 2022.

(51) Int. Cl. G01N 35/04; G01N 35/00

(52) U.S. Cl. CPC G01N 35/04; G01N 35/00584; G01N 2035/041; G01N 2035/0477

(57) ABSTRACT

A system and method for a hybridized control architecture for a liquid handler system. The hybridized control system can control the movement of the vessel movers of the liquid handler system using a hybridized movement control approach that incorporates both position, velocity and current-based control outputs. The control system can further dynamically control the relative degree to which velocity or position-based control is applied to the vessel movers based on the vessel movers' relative positions along the track system.

### CROSS REFERENCE TO RELATED APPLICATION

This application claims the benefit of U.S. Provisional Patent Application No. 63/373,359, entitled “HYBRIDIZED CONTROL ARCHITECTURE FOR VESSEL MOVER MOVEMENT CONTROL” filed Aug. 24, 2022, the disclosure of which is hereby incorporated by reference in its entirety for all purposes.

### BACKGROUND

Liquid handlers are robotic systems that are designed to dispense and process selected quantities of reagents, samples, or other liquids. Some liquid handlers are additionally adapted to analyze samples using, for example, immunoassay and/or clinical chemistry techniques. Such types of liquid handlers could be referred to as “analyzers” or “analyzer systems.” Some liquid handlers can include a number of modules (also referred to as stations) and a transport system to move samples between the various modules. It is highly desirable for the liquid handler transport systems to move the sample containers in a smooth manner, avoid causing the sample containers to collide with each other and, otherwise prevent liquids from spilling from their containers during transport. In particular, liquid spills waste reagents and/or samples (which could potentially impact the integrity of any tests being performed) and if the spill occurs on the track can also create obstructions that could negatively impair the movement of subsequent sample containers.

Liquid handlers are often used in in vitro diagnostics (IVD) applications. IVD allows labs to assist in the diagnosis of disease based on assays performed on patient fluid samples. IVD includes various types of analytical tests and assays related to patient diagnosis and therapy that can be performed by analysis of a liquid sample taken from a patient's bodily fluids, or abscesses. These assays are typically conducted with automated clinical chemistry analyzers onto which fluid containers, such as tubes or vials, containing patient samples have been loaded. The analyzer extracts a liquid sample from the vial and combines the sample with various reagents in special reaction cuvettes or tubes (referred to, generally, as reaction vessels). In some conventional systems, a modular approach is used for analyzers. A lab automation system can shuttle samples between one sample processing module (module) and another module. Modules may include one or more stations, including sample handling stations and analyzer modules/testing stations (e.g., a unit that can specialize in certain types of assays), or can otherwise provide testing services to the larger analyzer, which may include immunoassay (IA) and clinical chemistry (CC) stations. Some traditional IVD automation track systems comprise systems that are designed to transport samples from one fully independent module to another standalone module. This allows different types of tests to be specialized in two different stations/modules, or allows two redundant stations to be linked to increase the volume of sample throughput available. These lab automation systems, however, are often bottlenecks in multi-station analyzers. Relatively speaking, traditional lab automation systems lack large degrees of intelligence or autonomy to allow samples to independently move between stations.

As described further below, liquid handler systems include control systems that control the movement and/or routing of the vessel movers that transport the liquid samples between the various modules for processing. Conventional control systems make use of cascaded control schemes that tend to be overly conservative when tuned to reject disturbances and, hence, provide diminished performance. Further, variability in Hall sensor signals induces a significant challenge to accurate state estimation, which in turn results in diminished motion control performance (i.e., poor positioning accuracy and smoothness of motion) of the vessel mover, especially in the presence of unmodeled dynamics and external disturbances. Therefore, there is a need in the technical field for improved control schemes for liquid handler systems that are robust to external disturbances, provide smooth velocity profiles (in order to avoid spilling or splashing the liquid samples), and are highly accurate in positioning the liquid samples (because poorly positioned samples can fail to be processed by the modules or may need to be readjusted, which leads to poor efficiency).

### SUMMARY

Described herein are systems and methods for movement control architectures of vessel movers in liquid handler systems, particularly hybridized movement control architectures.

In one embodiment, the present disclosure is directed to a liquid handler system for processing a liquid sample that includes one or more modules configured to process the liquid sample, a track system interconnecting the modules that is configured to support one or more vessel movers, a sensor assembly configured to detect the one or more vessel movers, and a coil array associated with the track system, the coil array configured to interact with the magnet to define a linear electromagnetic actuator and propel the vessel mover along the track system. The vessel movers include a magnet and are configured to receive the liquid sample. The liquid handler system further includes a control system coupled to the coil array and the sensor assembly, that configured to estimate a state of the vessel mover, determine a velocity control output based on the estimated state of the vessel mover, determine a position control output based on the estimated state of the vessel mover, control movement of the vessel mover based on a fusion of the determined velocity control output and the determined position control output, determine a position of the vessel mover relative to a target, adjust a relative influence of the velocity control output and the position control output on the fusion based on the relative position of the vessel mover, and control the movement of the vessel mover based on the adjusted fusion.

In one embodiment, the present disclosure is directed to a control system for a liquid handler system for processing a liquid sample. The liquid handler system includes one or more modules configured to process the liquid sample and a track system interconnecting the one or more modules that is configured to support one or more vessel movers thereon. The one or more vessel movers include a magnet and are configured to receive the liquid sample. The liquid handler system further includes a sensor assembly configured to detect the one or more vessel movers and a coil array associated with the track system that is configured to interact with the magnet to define a linear electromagnetic actuator and propel the vessel mover along the track system. The control system configured to estimate a state of the vessel mover, determine a velocity control output based on the estimated state of the vessel mover, determine a position control output based on the estimated state of the vessel mover, control movement of the vessel mover based on a fusion of the determined velocity control output and the determined position control output, determine a position of the vessel mover relative to a target, adjust a relative influence of the velocity control output and the position control output on the fusion based on the relative position of the vessel mover, and control the movement of the vessel mover based on the adjusted fusion.

In one embodiment, the present disclosure is directed to a method of controlling a liquid handler system for processing a liquid sample, the liquid handler system including one or more modules configured to process the liquid sample, a track system interconnecting the one or more modules that is configured to support one or more vessel movers, a sensor assembly configured to detect the one or more vessel movers, and a coil array associated with the track system that is configured to interact with the magnet to define a linear electromagnetic actuator and propel the vessel mover along the track system. The one or more vessel movers include a magnet and are configured to receive the liquid sample. The method includes steps (by a control system coupled to the coil array and the sensor assembly) of estimating a state of the vessel mover, determining a velocity control output based on the estimated state of the vessel mover, determining a position control output based on the estimated state of the vessel mover, controlling movement of the vessel mover based on a fusion of the determined velocity control output and the determined position control output, determining a position of the vessel mover relative to a target, adjusting a relative influence of the velocity control output and the position control output on the fusion based on the relative position of the vessel mover, and controlling the movement of the vessel mover based on the adjusted fusion.

According to one aspect of some embodiments, the sensor assembly includes one or more Hall effect sensors. According to another aspect of some embodiments, the control system is configured to adjust the relative influence of the estimated position and the estimated velocity by adjusting a first gain applied to the velocity control output and a second gain applied to the position control output. According to one aspect of some embodiments, the track system comprises at least one printed circuit board (PCB) substrate. According to one aspect of some embodiments, the state of the vessel mover includes at least one of a position or a velocity of the vessel mover.

### FIGURES

The accompanying drawings, which are incorporated in and form a part of the specification, illustrate the embodiments of the invention and together with the written description serve to explain the principles, characteristics, and features of the invention. In the drawings:

FIG. 1 is a top down view of an exemplary sample handling module, in accordance with at least one aspect of the present disclosure.

FIG. 2 is a perspective view of an exemplary sample handling module in accordance with at least one aspect of the present disclosure.

FIG. 3 is a diagrammatic view of an exemplary integral, modular automation track system, in accordance with at least one aspect of the present disclosure.

FIG. 4 is a perspective view of an exemplary automation track system, in accordance with at least one aspect of the present disclosure.

FIG. 5 is a perspective view of an exemplary automation track system, in accordance with at least one aspect of the present disclosure.

FIG. 6 is a cross sectional view of an exemplary automation track system, in accordance with at least one aspect of the present disclosure.

FIG. 7 is a top down view of an exemplary automation track system, in accordance with at least one aspect of the present disclosure.

FIG. 8 is a diagram of a track segment of a liquid handler system, in accordance with at least one aspect of the present disclosure.

FIG. 9 is a diagram of a vessel mover actuator, in accordance with at least one aspect of the present disclosure.

FIG. 10 is a block diagram of a liquid handler system having a hybridized movement control architecture, in accordance with an embodiment of the present disclosure.

FIG. 11 is a block diagram of a hybridized movement control architecture, in accordance with an embodiment of the present disclosure.

FIG. 12 is a flow diagram of a process of hybridized movement control based on vessel mover positioning, in accordance with an embodiment of the present disclosure.

FIG. 13A is a graph illustrating position and velocity movement profiles for a non-hybridized, position-based movement control scheme.

FIG. 13B is a graph illustrating position and velocity error rates for a non-hybridized, position-based movement control scheme.

FIG. 14A is a graph illustrating position and velocity movement profiles for a non-hybridized, velocity-based movement control scheme.

FIG. 14B is a graph illustrating position and velocity error rates for a non-hybridized, velocity-based movement control scheme.

FIG. 15A is a graph illustrating position and velocity movement profiles for a hybridized movement control scheme, in accordance with an embodiment of the present disclosure.

FIG. 15B is a graph illustrating position and velocity error rates for a hybridized movement control scheme, in accordance with an embodiment of the present disclosure.

### DESCRIPTION

This disclosure is not limited to the particular systems, devices and methods described, as these may vary. The terminology used in the description is for the purpose of describing the particular versions or embodiments only, and is not intended to limit the scope.

As used herein, the terms “algorithm,” “system,” “module,” “engine,” or “architecture,” if used herein, are not intended to be limiting of any particular implementation for accomplishing and/or performing the actions, steps, processes, etc., attributable to and/or performed thereby. An algorithm, system, module, engine, and/or architecture may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular algorithm, system, module, and/or engine is, unless otherwise specified, for purposes of convenience of reference and not intended to be limiting to a specific implementation. Additionally, any functionality attributed to an algorithm, system, module, engine, and/or architecture may be equally performed by multiple algorithms, systems, modules, engines, and/or architectures incorporated into and/or combined with the functionality of another algorithm, system, module, engine, and/or architecture of the same or different type, or distributed across one or more algorithms, systems, modules, engines, and/or architectures of various configurations.

### Automated Liquid Handler Systems

A liquid handler or liquid handling robot is a system that is designed to dispense and process any type of liquid, including reagents and patient samples. Liquid handles are particularly adapted to automate workflows in life science laboratories, such as clinical laboratories or research laboratories. Some liquid handlers, which can be referred to as “analyzers” or “analyzer systems” are additionally adapted to process and perform tests on samples using, for example, immunoassay and/or clinical chemistry techniques.

Liquid handlers can include automation systems, either integrally or as modules coupled to the liquid handlers. Some liquid handler systems can include a number of modules or stations that are adapted to perform different tasks or tests. In these embodiments, the automation systems can include a transport system that is adapted to transport containers of samples and/or reagents between the various modules or stations. As noted above, transport systems can include friction-based movement systems, conveyor belts, and magnetically driven movement systems. Automation systems can further include sensor assemblies for detecting parameters associated with the containers or other aspects of the transport systems and control systems that are configured to control the movement of the containers accordingly.

In some embodiments, liquid handler systems can utilize a modular system including an automated clinical chemistry analyzer module and an automated immunoassay analyzer module, with sample loading capability to transport patient samples to and from analyzer module(s) where in vitro diagnostic assay analyses are performed. The system can be scalable in multiple configurations of the modules allowing customer yearly throughput needs ranging from low volume to very high volume/mega market segments (i.e., 500,000 to 5M or more tests per year).

In some embodiments, the automation system can be described as a process control manager (PCM) that manages the processing of samples. This includes providing input and output for samples into and out of the system, temporary storage of samples while awaiting processing, scheduling of samples for processing at various analyzers attached to the PCM, facilitation of the movement of samples throughout an automation track (including onto and off of the automation track), and, in some embodiments, maintenance of the automation systems. In various embodiments, a PCM can include a variety of different modules, including a sampler handler and a vessel mover.

The sample handler provides a means for the user to load and unload regular samples, STAT samples, and control/calibrator vials onto and off of the system. Within the sample handler, the robot subsystem is responsible for moving these tubes between other subsystems and modules, including the sample I/O (drawer trays), control storage, and the vessel mover.

The vessel mover subsystem handles this material distribution. Under normal conditions, a lab technician never operates the vessel mover track directly. The vessel mover manages carriers on an automation track that moves samples or reagents, each carrier having a dedicated type of holders. In some embodiments, liquid handler systems can include reagent carriers that are configured to accept a reagent cartridge and to transport the reagent cartridge, via the automation track, to a location accessible to the one or more analyzer modules. In some embodiments, a reagent carrier can be adapted to handle reagents from both an immunoassay module and clinical chemistry module.

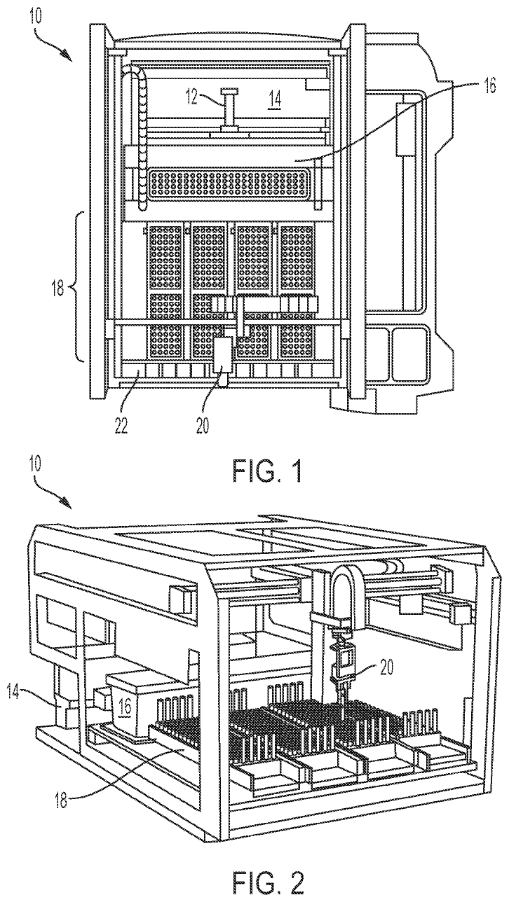

FIG. 1 shows a top down view of an exemplary sample handler 10 that may be used for some embodiments. Within this figure, sample handler 10 is oriented so that the front (i.e., the face that the operator interacts with) is at the bottom of the page, while the back of the automation track is located at the top of the page. Sample handler 10 includes a tube characterization station 12 at the robot/track interface. Tube characterization station 12 characterizes tubes and carriers when tubes are placed on carriers on track 14. This allows information to be ascertained about the identity of the tube placed in each carrier, and the physical condition of each tube (e.g., size of the tube, fluid level, whether there is a tube top cup, etc.) Adjacent to the tube characterization station 12 sits a control/calibrator storage region 14. This allows long-term refrigerated storage of control and calibrator fluids near the track, allowing these fluids to be easily placed into carriers on the track for movement to relevant locations in the analyzer. The location of storage 16 also allows input/output drawers 18 to be placed in the front of sample handler 10. In this example, there are four adjacent drawers 18 that can be individually opened and pulled out.

A robot arm 20 can move in two dimensions to pick up any of the tubes in drawers 18 and move those tubes to and from storage 16 and carriers on track 14. Robot arm 20 can be positioned by moving a gantry from the front to the back of a sample handler 10 while a carriage moves side to side along that gantry. Opposable end effectors can then be moved vertically to reach down to pick up tubes, closing the end effectors when they are properly positioned to engage the tube.

To assist the robot arm 20 in successfully engaging each tube, a drawer vision system 22 is placed above the drawers at the opening to the drawers. This allows a series of images to be taken, looking down at the tubes in the trays, as the trays are moved past the drawer vision system. By strobing a series of cameras, multiple images can be captured in a buffer, where each tube appears in multiple images. These images can then be analyzed to determine the physical characteristics of each tube. For example, diameters and heights of each tube can be determined. Similarly, the capped or uncapped states of each sample can be quickly determined. Furthermore, the presence or absence of a tube top cup (a small plastic well that is placed on top of a tube to allow a tube to transport a much smaller volume with greater depth of the sample, to allow aspiration to more easily take place) can be ascertained. Similarly, the characteristics of any cap can be ascertained by the images. This can include certain color markings on the cap to identify a given sample as a higher priority (STAT) sample.

The module manager PC can utilize this information to schedule samples to be moved from each tray in drawers 18 into carriers on track 14. The module manager PC can also instruct robot arm 20 how to interact with each tube, including identifying the proper height for the end effectors before engagement, and the proper force or distance to use when engaging the end effectors to accommodate multiple diameters of tubes.

FIG. 2 is a perspective view of a sample handler 10. In this example, track 14 is roughly parallel with the front face of drawers 18, while refrigerated storage 16 is a large physical object between drawers 18 and track 14. Meanwhile, robot arm 20 is moved on supports, well above the height of drawers 18 and refrigerated storage 16. In some embodiments, the sample handler 10 can include a tube characterization station 12 and a drawer vision system 22; however, these stations are omitted from the view in FIG. 2 in order to allow the internals of sample handler 10 to be better understood.

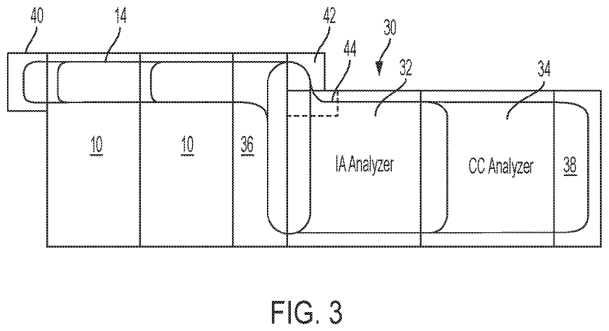

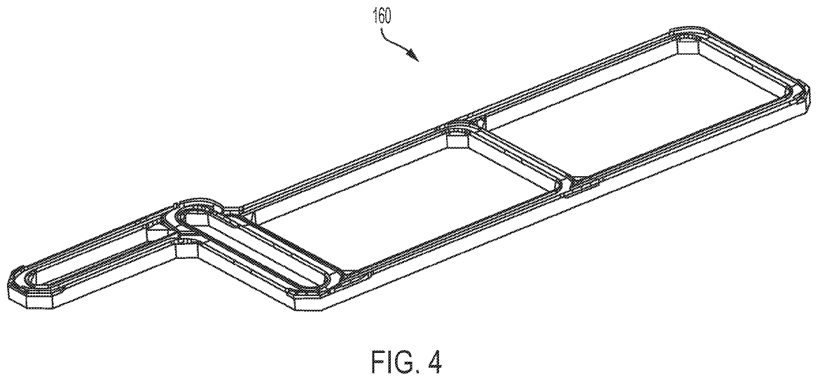

FIG. 3 illustrates the vessel mover components of the PCM that moves samples from an input region to analyzer modules, assists in handling those samples within the analyzer, and returns process samples to the output region of the sample handler. Multi module analyzer system 30 includes multiple interconnected modules. In this example, system 30 includes multiple sample handlers 10. By utilizing multiple sample handlers, more sample trays can be placed into the system, allowing a larger batch to be started at the beginning of the shift. Furthermore, this allows twice as many samples to be placed onto, and taken off of, the track. This means that, for larger systems with multiple analyzer modules that can operate in parallel, input/output throughput can match the analysis throughput of the parallel analyzers. For example, if an analyzer module can handle 500 samples per hour, and three analyzer modules are used, the input/output demand for feeding these modules may be up to 1500 samples per hour. In some embodiments, a single sample handler may not be able to handle this demand, necessitating adding multiple sample handlers to keep up with the input/output demand of the analyzer modules.

Furthermore, in some embodiments, one of the sample handlers can be set up to be used as an input, while the other sample handler can be set up as an output. By using a modular approach, a single sample handler 10 can be used but, for larger systems, two or more sample handlers can be used.

In an exemplary system 30, two analyzer modules are utilized. Analyzer module 32 is an immunoassay (IA) analyzer. Analyzer module 34 is a clinical chemistry (CC) analyzer. These two analyzer modules perform different assays, testing for different characteristics of patient samples.

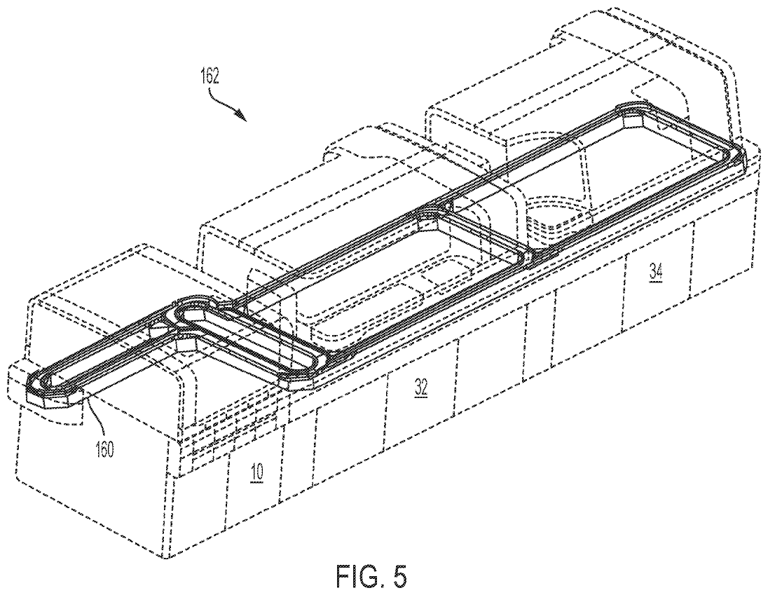

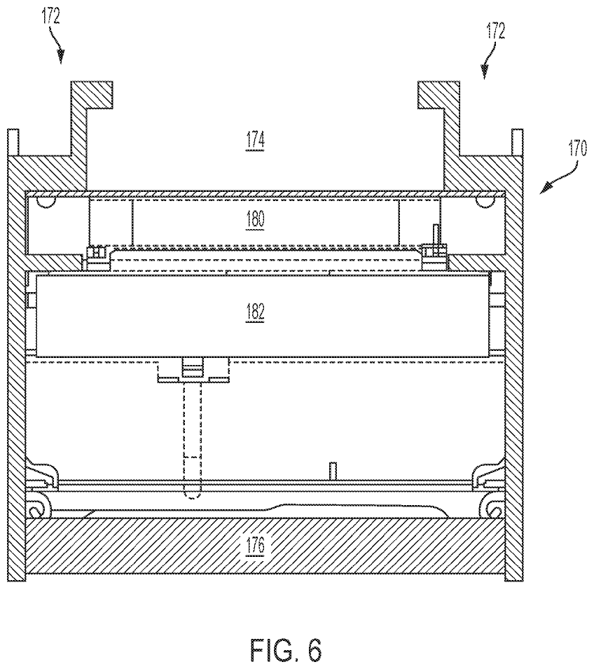

Track 14 is a multi-branching track that forms the heart of the vessel mover system. As can be seen, track 14 comprises branches and lengths that are provided integral to sample handlers 10 and analyzer modules of 32 and 34. The functions of the individual branches will be explained with respect to FIGS. 5 and 6. In addition to the track segments provided by these modules, additional modules 38, 40, and 42 provide short dedicated track sections that may be bolted to the track portions provided by the other modules. Track modules 36, 38, 40, and 42 provide powered track segments, without additional hardware related to sample handler modules or analyzer modules. Whereas modules 10, 32, and 34 may be full cabinets extending from a laboratory floor to the height of track 14, and above, track segment modules 36, 38, 40, and 42 may be bolt-on segments that extend from the cabinets of the other modules, without requiring floor-length support. Each of the modules in FIG. 3 can be bolted together in modular fashion, utilizing leveling hardware, such that each track segment between adjacent modules forms a virtually seamless track for carriers to traverse the vessel mover system.

In exemplary system 30, it can be seen that section 44 of the track of analyzer module 32 may need to be altered from the corresponding section of analyzer module 34. In some embodiments, the track segments of analyzer modules are in the same configuration as that shown in analyzer module 34 when they are shipped from the factory. This allows multiple analyzers to be placed in series, simply bolting their respective track segments together to form a long chain. In some embodiments, where there is an offset between the back track segment of the sample handler modules and the analyzer modules, as is illustrated in system 30, an S-shaped bend may be needed to allow carriers to move from the back track section of analyzer modules to the back track section of the sample handler modules. In this example, this S-shaped bend is provided by bolting on track section 42 and the altered track segment in area 44. Thus, it should be understood that the track segments within analyzer modules, while integral to those modules, can be extensively modified at the time of installation, allowing multiple configurations of the track segments within an analyzer module. However, it should be understood that these track segments are still very much integral to those analyzer modules. In some embodiments, the back of analyzer modules 32 and 34 are flush with the backs of sample handlers 10, eliminating the need for altering track segment 44 and section 42, entirely.

Track segments 38 and 40 are U-shaped track segments that provide returns between front track segments and back track segments, allowing traffic to move around the track 14 without traversing interior chord segments within sample handler or analyzer modules. This allows the track 14 to form an outer loop, with main traffic moving along the perimeter of the analyzer modules. Meanwhile, the internal track sections bypass the main loop, providing a direct path between two sides of each analyzer module (front to back), which serves as a route for local traffic. These chord segments can also be referred to as internal segments/track sections, bypass segments/track sections, or, in some cases, local track sections. These chord segments bypass the outer loop to provide access to a pipette. This allows small physical queues relevant to each sample handler or analyzer module to utilize those interior chord segments, without blocking the overall flow of track 14.

A specialized track segment module 36 facilitates sample return and branching within track 14 to allow the central computer system of the PCM to direct traffic in flexible ways. The outside track portions provide a way for samples to move from sample handler modules 10 to track segments of analyzer module 32, and vice versa. Meanwhile, the inner chord of track segment module 36 provides a branch whereby samples can move from analyzer 32 to analyzer 34 (in a counterclockwise manner), without moving into sample handler modules 10. This facilitates multiple tests on a single sample tube, allowing sample tubes to freely move between analyzer modules, regardless of how they are arranged on the right-hand side of system 30. This gives the PCM scheduling software flexibility in how samples order the tests within analyzer modules, without increasing traffic on the track segments relating to sample handling. Track segment 36 provides a boundary between sources and sinks (e.g., sample handler modules 10) and processors (e.g., analyzer modules 32 and 34) by providing a branching loop within section 36 (and section 42, in some embodiments). This loop allows sample carriers to move between the sources, sinks, and processors, including allowing samples to loop without returning to the sources and sinks.

Not shown in FIG. 3 is the central computer that includes a system instrument manager software component. The instrument manager software consolidates information from lower-level modules, such as sample handler 10 and analyzer modules 32 and 34, to present this information to an operator. The instrument manager receives information from the other modules via a network within the system (e.g., an internal Ethernet network). Information may be requested and provided asynchronously between the modules and central computer. The central computer can also work between the LIS and vessel mover systems to schedule samples and their movement within the system. The central computer can also work between the vessel mover systems and individual modules to handoff control of the samples and to initiate testing of samples once they arrive at a location.

Additional information regarding in vitro diagnostics systems can be found in U.S. patent application Ser. No. 16/319,306, published as U.S. Patent Application Pub. No. 2019/0277869A1, titled AUTOMATED CLINICAL ANALYZER SYSTEM AND METHOD, filed Jan. 18, 2019, which is hereby incorporated by reference herein in its entirety.

### PCB-Based Automation Track Configurations

Various liquid handlers can include a variety of different transport systems, including magnetic drive systems, friction-based track systems, or conveyor belts. For example, some liquid handlers include a track having a plurality of synchronously controlled magnetic coils. In these analyzer systems, the automation track is configured to move the sample carriers via synchronously controlled magnetic coils that propel the sample carriers along the analyzer system's track sections. However, conventional magnetically driven transport systems use metallic substrates for the automation track. Metallic substrates have several disadvantages, including cost and weight, as generally discussed above. Accordingly, embodiments of transport systems described herein include PCB-based substrates for the automation track. In these embodiments, each track segment can include one or more PCBs and coil arrays that are configured to electromagnetically actuate the vessel mover to transport the vessel mover therealong.

In some embodiments, track sections are divided up into a number of coil boards. A coil board includes a linear array of coils that can be mounted to the PCB substrate of the track. For straight sections of track, each coil board is straight, while, in corners or curves, coil boards include appropriately laid out coils to match the curve. All coil boards are controlled by master boards and node controllers. In some embodiments, each master board can control up to four different coil boards. Meanwhile, a node controller is centralized. A single node controller can control the entire vessel mover track. In some embodiments, multiple distributed node controllers can be used for expandability. For example, in larger systems, where the track extends for several meters, multiple node controllers may be used, and control of carriers can be handed off as they traverse different regions of the track network.

FIG. 4 shows a perspective view of track system 160. Track system 160 is configured to have a single sample handler unit and two analyzer modules. FIG. 5 shows track system 160 situated in a fully operational analyzer system 162 that includes a sample handler module 10 and two analyzer modules of 32 and 34. As can be seen, track system 160 is housed within the modules themselves, such that the track is not easily accessible to an operator. However, track 160 and analyzer system 162 utilize a modular design whereby track components reside within each module and each module can easily be linked together to join the track segments by placing adjacent modules in proximity and linking them. Covers above track 160 can be removed during installation or service to facilitate linking of tracks. In some embodiments, track sections can be expanded by placing modules adjacent to one another and bolting the track sections of each module together forming a single multi-branching track system, such as track 160. Signaling cables can be daisy-chained together for ease of expanding control.

FIG. 6 shows a cross-sectional view of the track section 170. Track section 170 may be track section used in track 160. In this embodiment, carriers ride between rails 172 on a track surface 174. In some embodiments, rails 172 are aluminum extrusions that also include vertical sides on the exterior of the track components underneath track surface 174. These aluminum extrusions can include brackets to easily bolt internal components to these side pieces to form a track unit. In the embodiments described herein, the track surface 174 is a PCB. In various embodiments, the PCB track surface 174 can include one or more coatings or other components. At the bottom of the side components of rails 172 resides a baseplate 176. Baseplate 176 can be mounted to the modules containing track section 170 and provide support for the track system.

Beneath track surface 174 reside a series of coils 180. The longitudinal direction of track section 170 is into the page; as you travel along the track section 170, you encounter additional coils 180. Coils 180 are preferably mounted to coil boards 182 and are preferably laterally oblong to allow more coil density in the longitudinal direction of the track. In some embodiments, coil boards 182 are printed circuit boards (PCB) that include several coils 180 in the longitudinal direction. An exemplary coil board is 250 mm in length, accommodating all of the coils 180 needed for 250 mm of track. Thus, a typical track section will have several coil boards 182, including dozens of coil boards 182 to make up an entire track system. In some embodiments, coil boards 182 receive a control signal to indicate the trajectory to apply to a carrier traveling along that coil board and a power source of 24 VDC. Coil boards 182 include coils 180, motor drivers to drive those coils, and one or more sensors to detect the presence of carriers traversing the track surface above the coil board by detecting the magnets of the carrier. These sensors can include Hall Effect sensors to detect the presence and location of the carrier traveling along the coil board. Accordingly, there may be more sensors than coils, allowing fine resolution of the position of a carrier traversing track surface 174. Furthermore, an RFID receiver may be utilized to receive an RFID signal that identifies the carrier traveling along the track surface. In some embodiments, magnetic signatures unique to each carrier can be detected by the Hall Effect sensors to determine the identity of the carrier magnetically. For example, a carrier traversing an array of Hall Effect sensors can be characterized at manufacturing to identify a unique signature of that carrier based on rise times and signal artifacts that are detected by the Hall Effect or sensor array as magnets in the carrier travel over that array. In some embodiments, smaller magnets than the main drive magnets may be placed in the bottom portion of a carrier to intentionally create a unique signature for each carrier at manufacturing. This magnetic signature can be correlated to an identity of each carrier in software for the vessel mover system. An exemplary linear synchronous motor drive system is described in U.S. Pat. No. 9,346,371.

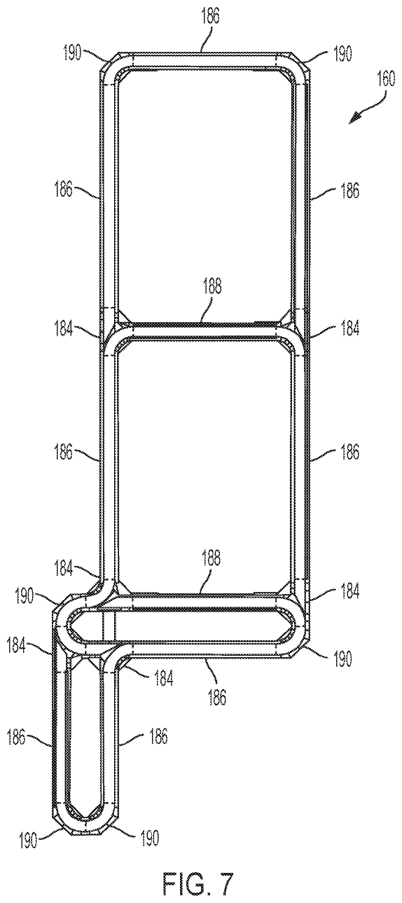

FIG. 7 shows a top view of an exemplary track system 160 with the individual track sections identified. There are generally four types of track sections that make up the modular design of track system 160. Switching segments 184 are branches in the track. The track surface for switching segments 184 is generally T-shaped, with rounded inside edges. Meanwhile, the rails of switching segments 184 include one straight rail (top of the T), one radiused rail (one inside corner of the T), and one radiused rail that includes a switching mechanism (other inside corner of the T). This switching mechanism is a movable rail component that can be turned a predetermined number of degrees to act as a switch (e.g., 20-30 degrees, depending on geometry). On one side of the rail component, it acts as a straight rail. On the other side of the rail component, the rail presents itself as a radiused rail forming an outside corner of a turn. By switching a movable rail component, that movable rail component can either provide the outside of a turn, or a simple straightaway rail. Thus, the mobile component provides a binary switch whereby switching segment 184 presents itself as a turn or as a straightaway, depending on the control signal. This can be used to divert individual carriers based on the state of the switching segment. It should be noted that, while the track may be bidirectional, only one end of the T can be connected to the center portion of the T to form a turn. Thus, while switching segments 184 may have three ports, essentially, one port may be switched to either of the other two ports, but those two ports cannot be joined together.

A simpler type of track section is a straightaway, such as outside straightaway 186 or inside straightaway 188. The basic components of straightaways 186 and 188 are a track surface and rails, with a series of coil boards providing linear motive forces along the direction of that straightaway. Straightaways 186 and 188 are identified separately in FIG. 7 because inside straightaways 188 can be operated under the control of the local module, rather than a vessel mover controller that controls the entire track 160, in some embodiments. This allows each local module to independently operate track sections 188 to act as a local random-access queue. The vessel mover controller can hand off control to the local module after moving a carrier from a switching segment 184 to the local inside straightaway 188. Similarly, when a local module has completed aspirations on a sample residing on inside straightaway 188, that module may move the sample carrier into a switching segment 184 and hand off control to the vessel mover controller. In some embodiments, inside track sections 188 still operate under the control of the vessel mover controller that controls the entire track system 160. To control a local queue on inside straightaway 188, the local module can communicate directly with the vessel mover controller to request movement of carriers within track section 188. This allows the local module to manifest control over carriers in its queue by using a request to acknowledge the communication system, allowing the vessel mover controller to have expertise in moving individual carriers and operating track system 160.

A fourth type of track segment is a curved track segment 190. Curved track segment 190 provides a 90° bend with a predetermined radius (or other angular bend). This radius is preferably the same as the radius used in turns when switching track segments 184 are switched into a curve. The radius is chosen to minimize the space impact of curves while, at the same time, allowing carriers to move quickly around curves without encountering drastic lateral forces. Thus, the space requirements and speed requirements of automation track 160 can determine the radius of curved segments 190.

Electrically, curved segments 190 are substantially the same as straightaways 186 and 188. Each of these segments includes a plurality of coils that are activated, in sequence, to provide a linear motor in conjunction with magnets in the bottoms of carriers. Each coil is activated to provide a push or pull force on drive magnets placed in the bottom of each carrier. The speed at which coils are activated in sequence determines the speed of the carrier on that section of track. Furthermore, carriers may be moved into a position and stopped at a predetermined location with high resolution by activating coils at that location.

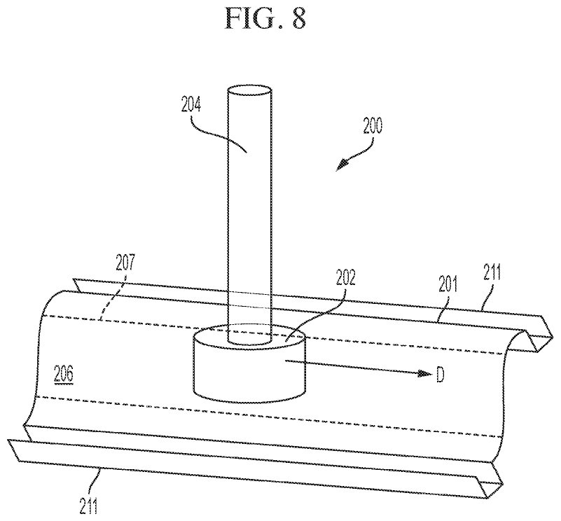

FIG. 8 shows an illustrative embodiment of a track segment 201 of an automation track system 200, such as the track system 160 as shown in FIGS. 4-7. As generally described above, the automation track system 200 is configured to support one or more vessel movers 202, which are configured to receive a vessel 204 (also referred to as a “carrier” or “sample carrier”) therein. The track segment 201 can include a riding surface 206, which is the upper surface of the track segment 201 that supports the vessel mover 202 thereon and along which the vessel mover 202 is transported between the modules or components of the automation track system 200. In some embodiments, the riding surface 206 can include an active region 207 that the vessel mover 202 is intended to move along. As shown, the active region 207 is the area between the dashed lines. The active region 207 can generally correspond to the medial portion of the riding surface 206. If any liquid contaminants are present on the active region 207, they could negatively impact or otherwise impair the movement of the vessel movers 202, as noted above. In some embodiments, the track segment 201 could include a PCB substrate, as generally described above.

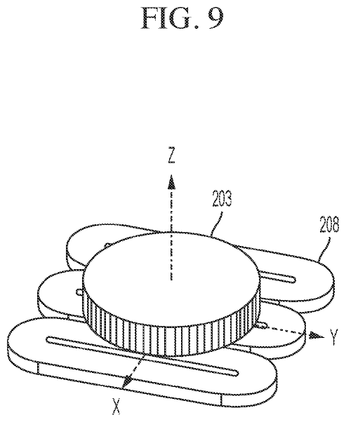

Further, as shown in FIG. 9, the track system 200 can include one or more coil arrays 208 associated with each track segment 201. The coil arrays 208 can be configured to generate a magnetic field that interacts with the magnet 203 positioned within the base of the vessel movers 202. The coil arrays 208 and the vessel mover magnet 203 can collectively define a linear electromechanical actuator. By synchronously controlling the coil arrays 208, the track system 200 can propel the vessel movers 202 (and, thus, the vessels 204 containing any samples or other liquids held thereby) across the track segments 201 to the desired module or other component of the liquid handler system.

Additional information regarding transport systems for liquid handlers can be found in U.S. patent application Ser. No. 16/319,306, which is incorporated by reference above.

### Hybridized Movement Control Architectures for Liquid Handler Systems

Liquid handler systems conventionally make use of position or velocity-based control schemes for controlling the movement of the vessel movers throughout the liquid handler system. In position-based control schemes, the control system aims to have the end position of the vessel mover 202 meet a predetermined target within specified error bounds. In velocity-based control schemes, the control system aims to have the velocity of the vessel mover 202 match a predetermined velocity profile. However, these conventional movement control schemes have issues. In particular, position control schemes tend to exhibit a high degree of accuracy in the final or target position of the vessel mover. However, such position control schemes also tend to exhibit inconsistent velocity profiles for the vessel movers, which can lead to inefficiencies in the routing of the vessel movers and potentially result in spills due to rapid changes in the vessel movers' velocities. This is particularly true in situations when the position sensing is noisy, resulting in velocity estimates that are non-smooth. Smoothing of the position and velocity estimates using an observer or state estimator would be at the expense of accuracy of the state estimates, and consequentially accuracy of trajectory tracking. The noisy estimates of velocity also limit the velocity controller gains to reduce velocity ripple or non-smoothness. This in turn limits the tracking performance achieved by the motion control. Conversely, velocity control schemes tend to exhibit smooth velocity profiles for the vessel mover. However, such velocity control schemes also exhibit a relatively low degree of accuracy in the final or target position of the vessel mover. These issues can be especially problematic in the context of high throughput liquid handler systems because inefficiencies in routing or the need for additional corrective movements in systems that are processing thousands of samples can compound sample processing delays, which in turn can significantly decrease the processing efficiency of the liquid handler systems. Further, because these systems are processing liquid samples, the movement control schemes need to be specifically tailored to provide smooth velocity profiles that avoid imparting sudden movements of the vessel movers that could result in sample spillage. For all of these reasons, a hybridized movement control scheme is described herein that provides all of the benefits of both position and velocity control schemes, without any of the corresponding downsides of those movement control schemes.

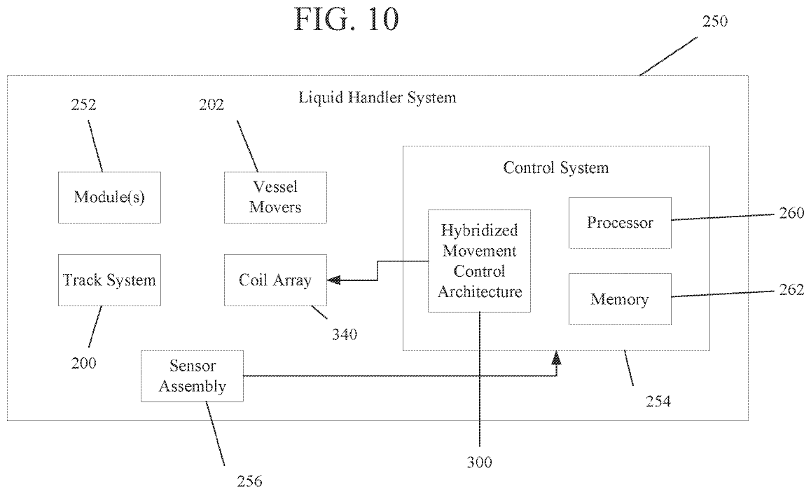

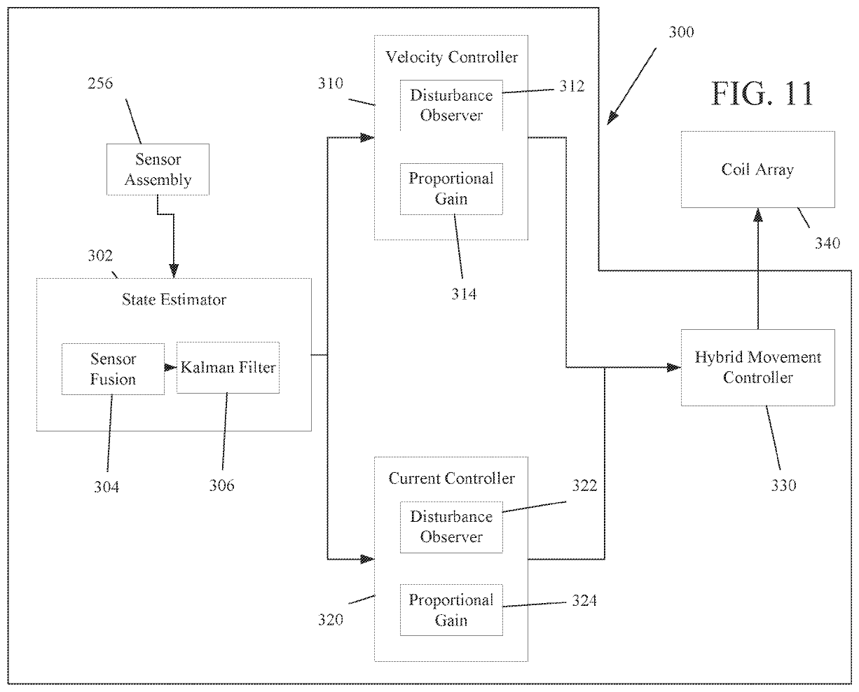

FIG. 10 is a block diagram of an illustrative liquid handler system 250 that utilizes a hybridized movement control architecture 300. As generally described above, a liquid handler system 250 can include one or more modules 252 that are configured to process liquid samples, a track system 200 interconnecting the various modules 252, vessel movers 202 that receive the liquid samples and transport the liquid samples between the various modules 252 along the track system 200, and a coil array 340 associated with the track system 200 that is configured to drive the vessel movers 202 therealong. The liquid handler system 250 can further include a control system 254 that is coupled with the coil array 340 and is configured to control the coil array 340 in order to control the movement and routing of the vessel movers 202 along the track system 200 in order to transport the liquid samples between the modules 252 in particular sequences and with particular timings according to the types of liquid samples being processed by the liquid handler system 250.

In this embodiment, the control system 254 can include a hybridized movement control architecture 300 that is configured to implement a hybrid velocity and position-based movement control scheme for controlling the movement of the vessel movers 202 by electrically controlling the coil array 340, which drive the vessel movers 202. In one embodiment, the control system 254 can include a processor 260, a memory 262, and/or other hardware, software, or firmware components for executing the hybridized movement control architecture 300. In one embodiment, the hybridized movement control architecture 300 can be embodied as instructions stored in the memory 262 that, when executed by the processor 260, cause the control system 254 to perform the corresponding steps of controlling the coil array 240 to move the vessel movers 202 as dictated by the hybridized movement control architecture 300. As noted above, the liquid handler system 250 can further include a sensor assembly 256 (e.g., one or more Hall effect sensors) that is configured to sense the position and/or movement of the vessel movers 202 (e.g., via the magnets embedded therein) along the track system 200. The control system 254 can receive output (e.g., data or signals) from the sensor assembly 256 in order to track the state (e.g., position and velocity) of the vessel movers 202. Based on the output from the sensor assembly 256, the control system 254 can control the movement of the vessel movers 202 accordingly.

FIG. 11 is a block diagram of an illustrative hybridized movement control architecture 300. The hybridized movement control architecture 300 and/or components thereof can be implemented as hardware, software, firmware, or any combination thereof. In this embodiment, the hybridized movement control architecture 300 can include a state estimate 302 that is configured to estimate the state of a vessel mover 202 of the liquid handler system 250. The “state” of the vessel mover 202 can include, for example, the position or velocity of the vessel mover 202. The state estimator 302 can include a sensor fusion block 304 that receives data and/or signals from the sensor assembly 256 (e.g., Hall effect sensors) and fuses the sensor data and/or signals together to create a measurement signal. The state estimator 302 can further include a filter 306 (e.g., a Kalman filter) that uses the raw fused sensor data along with a model of the plant dynamics to output a measurement of the estimated state of the vessel mover 202.

As noted above, the hybridized movement control architecture 300 utilizes a hybridized approach to control the movement of the vessel movers 202 using both position-based control and velocity-based control. In this embodiment, the hybridized movement control architecture 300 can further include a velocity controller 310 that is configured to control the velocity of the vessel movers 202 and a current controller 320 that is configured to control which of the coils of the coil array 340 current is applied to, which in turn controls the position of the vessel movers 202. In this embodiment, the hybridized movement control architecture 300 can control the relative influence of the velocity and the positioned-based controls via a proportional gain 314, 324 that are applied to the output of the velocity controller 310 and the current controller 320. In some embodiments, which are described further below, the hybridized movement control architecture 300 can adjust the relative influence of the position and velocity controls by adjusting the proportional gains 314, 324 applied to the outputs of the velocity controller 310 and the current controller 320. The values of the proportional gains 314, 324 could be a number from 0.0 to 1.0, for example. Note that in some implementations, one of the proportional gains 314, 324 could be zeroed out to shift to a non-hybridized control scheme.

In some embodiments, either one or both of the velocity controller 310 and the current controller 320 can further include a disturbance observer 312, 322 that is configured to identify the presence and/or effects of any external disturbances on the movement of the vessel movers 202. External disturbances could include, for example, the presence of any spills or other contaminants on the track system 200. In some embodiments, transient or persistent changes in frictional drag on the vessel movers 202 could be modeled as a disturbance. The disturbance observers are able to classify the nature of disturbances and modify existing, or select alternate control schemes to minimize the effects on vessel mover motion goals.

The hybridized movement control architecture 300 can further include a hybrid movement controller 330 that is configured to receive the outputs of the velocity controller 310 and the current controller 320 (including the proportional gains 314, 324 applied thereto) and hybridize the outputs to generate a single control output for the vessel mover 202 that based on the combination of the two outputs. In some instances, controller gains may not be proportional. Accordingly, hybrid movement controller 330 can be coupled to the coil array 340 to cause the vessel mover 202 to move accordingly. In some embodiments, a low-bandwidth position control block with gain scheduling can be placed between state estimate 302 and velocity controller 310. In some embodiments, velocity controller 310 can feed into current controller 320, making them operate in series rather than parallel. In some embodiments, hybrid movement controller 330 is optional.

An exemplary hybridized motion control comprises of a weighted combination of position and velocity tracking control such that during the main phase of motion towards the end-state (target), the control is predominantly velocity-tracking control with slow/small correction to the position tracking error. This is achieved using a low-bandwidth position controller in tandem with the velocity-tracking controller with the resulting output of the higher-level controller being the weighted fused output of the two. Further, the weighting can be dynamically adjusted based on the motion state. In one embodiment of the scheme, the control gains for the position control are set low during the main course of the motion so as to ensure a low-bandwidth (slow) correction to in-motion position-tracking errors while the motion control is predominantly in velocity-tracking mode. This provides a smooth velocity control profile and at the same time minimize position-tracking errors during the move. During the end-phase of the motion when the vessel mover is within a certain range of its target state, the control gain for the position control is suitably increased to accurately track the end-position target to the desired level. The dynamic adjustment of the weighting of the velocity and position-tracking control is actively managed by the supervisory hybrid control scheme that may for example, run an algorithm as described briefly above.

The end result is smooth motion tracking during the main course of motion of the vessel mover with in-motion position errors maintained within acceptable limits and achieving end-position target position during the final (settling) phase of motion to the required level of accuracy and precision. The higher-level hybrid control feeds into the current controller that provides the coil voltage inputs required to develop the required electromechanical thrust force to drive the desired motion.

The main departure of this control architecture relative to the commonly deployed motor control paradigm is as follows: The traditional nested architecture-based motor control consists of an outer position control loop whose output serves as the reference input to a velocity control second-stage which then further feeds into the current-control third-stage. As described earlier, in situations where the feedback for control consists of position-sensing and where the position measurements are noisy, such a scheme suffers from non-smooth velocity profile-tracking and/or limited-bandwidth of control which in turn, degrades motion-tracking performance and quality.

On the other hand, the hybrid control architecture actively manages a compromise between position and velocity-tracking in a dynamic fashion so as to achieve smooth motion trajectories of the vessel mover(s) and at the same time achieve end-position target to the required level of accuracy and precision. It is worth noting that the hybrid-control strategy can be incorporated into control schemes that may use traditional PID-control, more advanced techniques such as disturbance observer-based control (deployed in the studies involving the hybrid control scheme), and adaptive control that afford improved disturbance-rejection capability and improved tracking performance.

It should be noted that although the hybridized movement control architecture 300 is primarily described as controlling a vessel mover 202, it should be understood that this is simply for brevity. In implementation, the hybridized movement control architecture 300 could be controlling the movements of a number of vessel movers 202, either simultaneously or in parallel with each other. Accordingly, the block diagram of the hybridized movement control architecture 300 could be applied to controlling the movement of any number of vessel movers 202. Therefore, nothing in this disclosure should be understood to be limiting the hybridized movement control architecture 300 to controlling the movement of a single vessel mover 202.

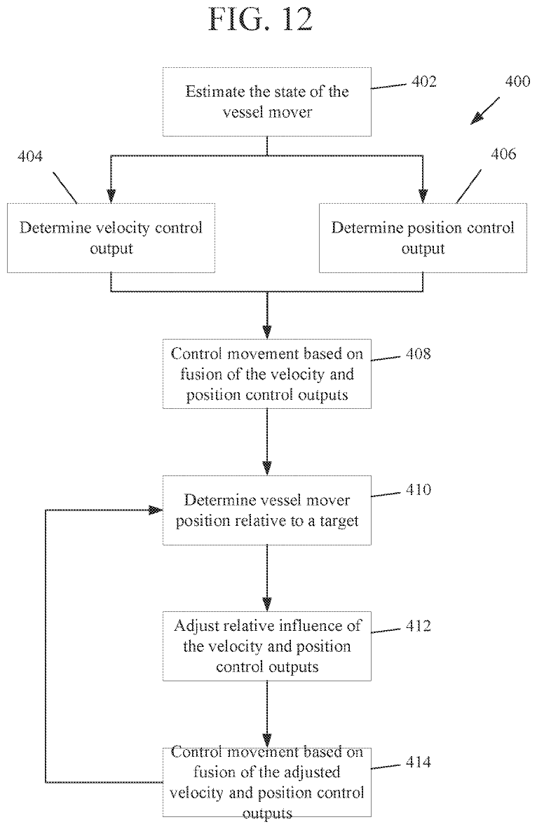

As briefly noted above, in some embodiments, the hybridized movement control architecture 300 can adjust the relative influence (e.g., the proportional gains 314, 324) of the velocity and position-based movement controls according to the relative position of the vessel mover 202. In one embodiment, the relative position of the vessel mover 202 could include the position of the vessel mover 202 with respect to a target, such as a destination or end-point for the vessel mover 202. This could be beneficial because, for example, it would allow the hybridized movement control architecture 300 to increase the relative influence of the velocity-based movement control when the vessel mover 202 is far from the target when a smooth velocity profile is desired. Further, the hybridized movement control architecture 300 could increase the relative influence of the position-based movement control when the vessel mover 202 is approaching the target when a high degree of accuracy in the positioning of the vessel mover 202 is desired (e.g., so that the vessel mover 202 fully reaches the intended destination). One example of such a process 400 is shown in FIG. 12. The illustrated process 400 or individual steps thereof can be executed by, for example, the hybridized movement control architecture 300 shown in FIGS. 10 and 11. In one embodiment, the process 400 can be stored as instructions in a memory 262 that, when executed by the processor 260, cause the control system 254 to perform the described steps.

Accordingly, a control system 254 executing the process 400 can estimate 402 (e.g., via the state estimator 302) the state of a vessel mover 202. Based on the estimated state, the control system 254 can correspondingly determine 404 a velocity control output and determine 406 a position control output associated with controlling the vessel mover 202 according to a velocity-based control scheme and a position-based control scheme, respectively. The velocity control output and the position control output can be determined 404, 406 using techniques known with closed loop controllers (e.g., proportional-integral-derivative controllers) and/or open loop controllers. The control system 254 can fuse the velocity and position control outputs and control 408 the movement of the vessel mover 202 based accordingly, i.e., as a hybridization of the velocity and position control outputs using a classical cascade approach.

In addition to generally controlling the movement of the vessel movers 202 using a hybridized control approach, the control system 254 can also monitor the vessel movers 202 as they move between the modules 252 along the track system 200 and adjust the manner in which the vessel movers 202 are moved based on their relative positions. Accordingly, the control system 254 can determine 410 the position of the vessel mover 202 relative to a target. The target could include, for example, the end point or destination for the vessel mover 202. An end point could include, for example, a location within or adjacent to a module 252 that is suitable for processing the liquid sample carried by the vessel mover 202. In one embodiment, the control system 254 could determine the position of the vessel mover 202 via the sensor assembly 256. Based on the determined 410 position of the vessel mover 202, the control system 254 can adjust 412 the relative influence of the velocity and position control outputs on the hybridized movement control and control 414 the movement of the vessel mover 202 accordingly. In one embodiment, the control system 254 can adjust 412 the relative influences of the individual control outputs by adjusting the proportional gains 314, 324 applied thereto, as described above in connection with FIG. 11. As noted above, changing the position and velocity control components of the hybrid movement control scheme can be beneficial because in certain circumstances it could be beneficial to increase the degree of velocity-based control on the vessel movers 202 (e.g., when the vessel movers 202 are relatively far from their destinations) or increase the degree of position-based control on the vessel movers 202 (e.g., when the vessel movers 202 are relatively close to their destinations). Further, the steps of determining 410 the vessel mover's relative position and adjusting 412 the relative influences of the velocity and position control outputs can be continuously or repeatedly throughout the movement of the vessel movers 202, thereby allowing the control system 254 to dynamically react to the continuously changing state of the liquid handler system 250 and both precisely and efficiently control the routing of the vessel movers 202.

In some embodiments, the control parameters for the individual position and velocity controllers can be adaptively changed (in real-time) based on inferred or sensed changes to the system (e.g., state of track surface), environment, or workflow requirements. For example, a demand for higher throughput at certain busy times could result in selection of a different motion profile with changes to motion parameters, while a slower motion profile that is more energy efficient can be used at other times.

### EXAMPLES

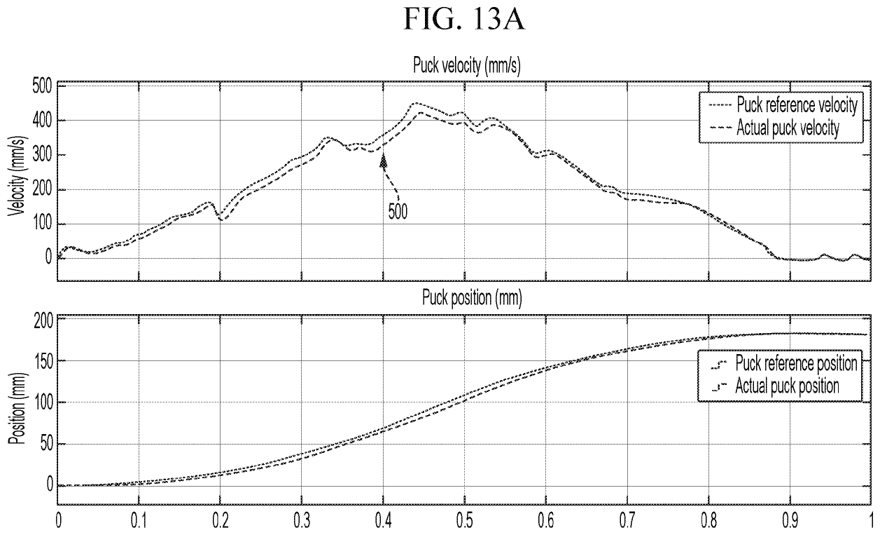

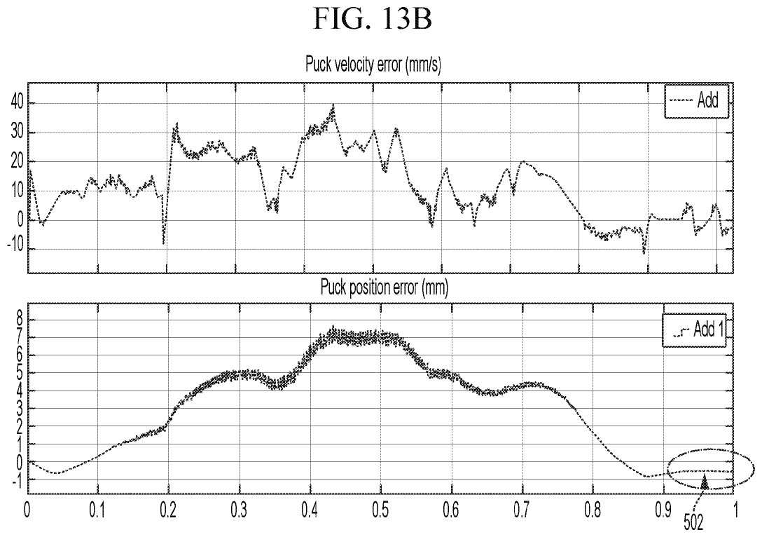

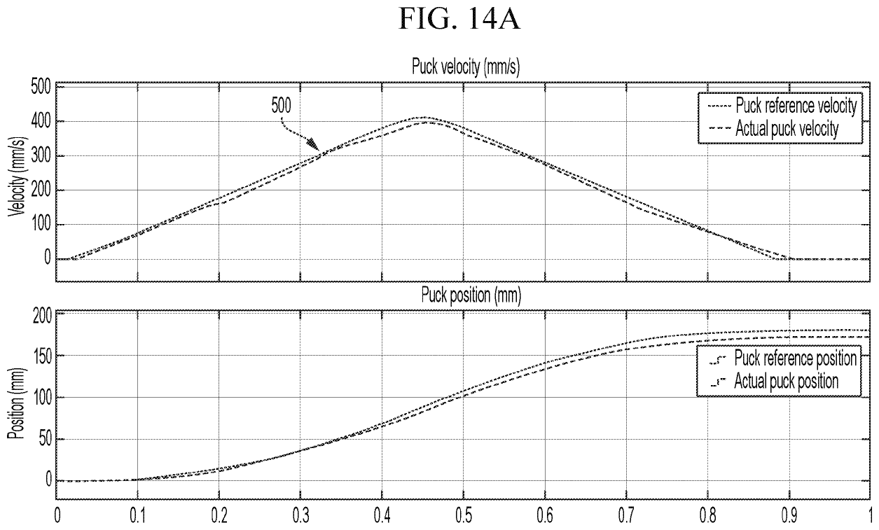

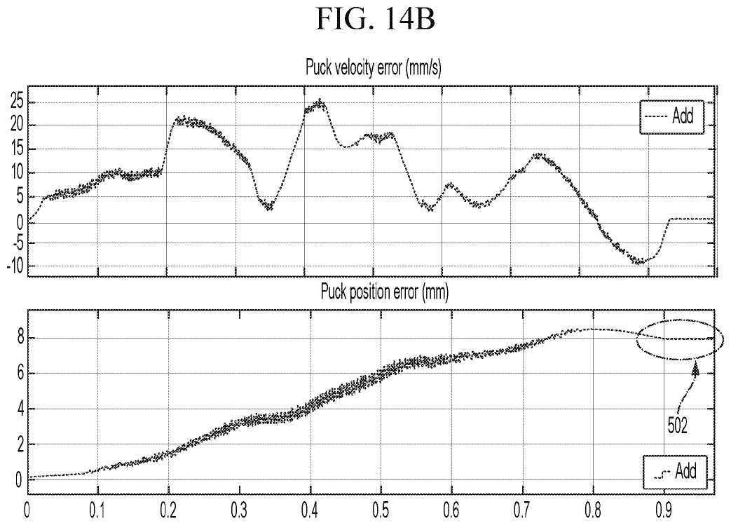

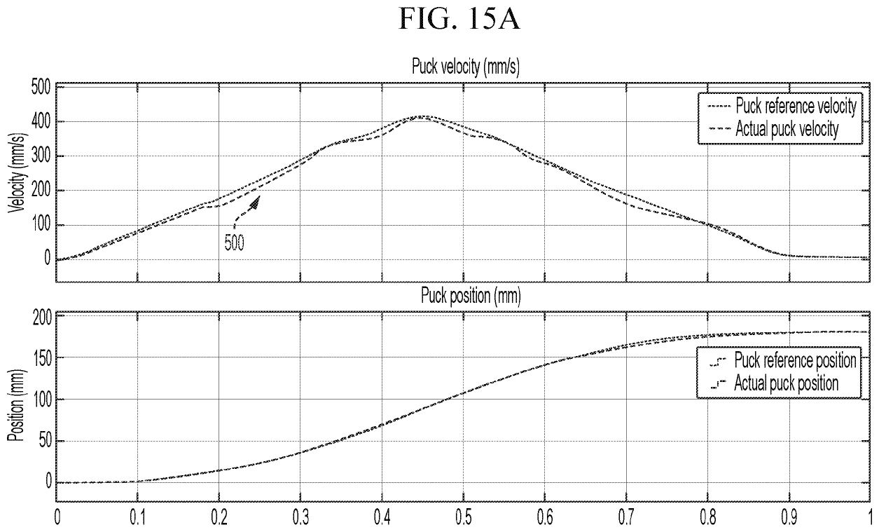

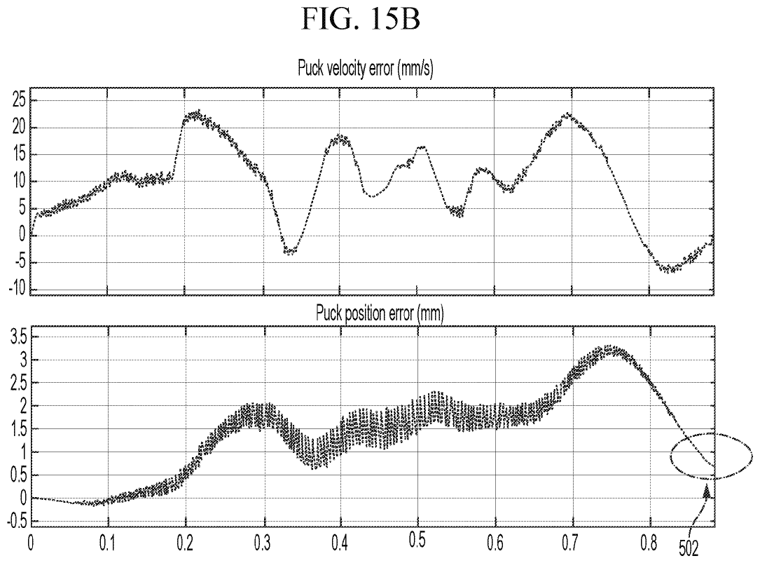

To illustrate the various movement control concepts described above, proof-of-concept studies were performed to demonstrate the efficiency and precision of the hybridized control architecture described herein relative to solely position-based and velocity-based control schemes. In particular, FIGS. 13A and 13B show graphs illustrating position and velocity movement profiles and error rates, respectively, for a solely position-based control scheme for controlling a simulated vessel mover. As can be seen, the position-based control scheme provides good position accuracy with a final position 502 (i.e., the target) achieved with an error of only approximately 0.5 mm. However, the position-based control scheme exhibits a non-smooth velocity profile 500, which can create a potential risk for splashing or spilling the liquid sample payload. Correspondingly, FIGS. 14A and 14B show graphs illustrating position and velocity movement profiles and error rates, respectively, for a solely velocity-based control scheme for controlling a simulated vessel mover. As can be seen, the velocity profile 500 is smooth, but this control scheme exhibits a relatively high error (approximately 8 mm) in the end position 502 of the vessel mover 202. Finally, FIGS. 15A and 15B show graphs illustrating position and velocity movement profiles and error rates, respectively, for a hybrid control scheme for controlling a simulated vessel mover. As can be seen, the hybrid control scheme described herein exhibits both a smooth velocity profile 500 and a high degree of accuracy in the end position 502 (an error of approximately 0.8 mm) of the vessel mover 202. Accordingly, the hybrid control scheme described herein can provide all of the advantages of the individual position and velocity-based control schemes, without the corresponding disadvantages. These advantages are especially valuable in the context of liquid handler systems 250 because such systems need to both avoid spilling or splashing the liquids as they are processed by the systems and have a high degree of accuracy in positioning the vessel movers 202 in order for the samples to be processed correctly and efficiently.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

Aspects of the present technical solutions are described herein with reference to flowchart illustrations and/or block diagrams of methods, apparatuses (systems), and computer program products according to embodiments of the technical solutions. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present technical solutions. In this regard, each block in the flowchart or block diagrams can represent a module, segment, or portion of instructions, which includes one or more executable instructions for implementing the specified logical function(s). In some alternative implementations, the functions noted in the blocks can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A second action can be said to be “in response to” a first action independent of whether the second action results directly or indirectly from the first action. The second action can occur at a substantially later time than the first action and still be in response to the first action. Similarly, the second action can be said to be in response to the first action even if intervening actions take place between the first action and the second action, and even if one or more of the intervening actions directly cause the second action to be performed. For example, a second action can be in response to a first action if the first action sets a flag and a third action later initiates the second action whenever the flag is set.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A liquid handler system for processing a liquid sample, the liquid handler system comprising:
one or more modules configured to process the liquid sample;
a track system interconnecting the one or more modules, the track system configured to support one or more vessel movers thereon, the one or more vessel movers comprising a magnet and configured to receive the liquid sample;
a sensor assembly configured to detect the one or more vessel movers;
a coil array associated with the track system, the coil array configured to interact with the magnet to define a linear electromagnetic actuator and propel the vessel mover along the track system; and
a control system coupled to the coil array and the sensor assembly, the control system configured to:
estimate a state of the vessel mover,
determine a velocity control output based on the estimated state of the vessel mover,
determine a position control output based on the estimated state of the vessel mover,
control movement of the vessel mover based on a fusion of the determined velocity control output and the determined position control output,
determine a position of the vessel mover relative to a target,
adjust a relative influence of the velocity control output and the position control output on the fusion based on the relative position of the vessel mover, and
control the movement of the vessel mover based on the adjusted fusion.

2. The liquid handler system of claim 1, wherein the sensor assembly comprises one or more Hall effect sensors.

3. The liquid handler system of claim 1, wherein the control system is configured to adjust the relative influence of the estimated position and the estimated velocity by adjusting a first gain applied to the velocity control output and a second gain applied to the position control output.

4. The liquid handle system of claim 1, wherein the track system comprises at least one printed circuit board (PCB) substrate.

5. The liquid handle system of claim 1, wherein the state of the vessel mover comprises at least one of a position or a velocity of the vessel mover.

6. A control system for a liquid handler system for processing a liquid sample, the liquid handler system comprising one or more modules configured to process the liquid sample, a track system interconnecting the one or more modules that is configured to support one or more vessel movers thereon, the one or more vessel movers comprising a magnet and configured to receive the liquid sample, a sensor assembly configured to detect the one or more vessel movers, and a coil array associated with the track system that is configured to interact with the magnet to define a linear electromagnetic actuator and propel the vessel mover along the track system, the control system configured to:
estimate a state of the vessel mover,
determine a velocity control output based on the estimated state of the vessel mover,
determine a position control output based on the estimated state of the vessel mover,
control movement of the vessel mover based on a fusion of the determined velocity control output and the determined position control output,
determine a position of the vessel mover relative to a target,
adjust a relative influence of the velocity control output and the position control output on the fusion based on the relative position of the vessel mover, and
control the movement of the vessel mover based on the adjusted fusion.

7. The control system of claim 6, wherein the sensor assembly comprises one or more Hall effect sensors.

8. The control system of claim 6, wherein the control system is configured to adjust the relative influence of the estimated position and the estimated velocity by adjusting a first gain applied to the velocity control output and a second gain applied to the position control output.

9. The control system of claim 6, wherein the track system comprises a printed circuit board (PCB) substrate.

10. The control system of claim 6, wherein the state of the vessel mover comprises at least one of a position or a velocity of the vessel mover.

11. A method of controlling a liquid handler system for processing a liquid sample, the liquid handler system comprising one or more modules configured to process the liquid sample, a track system interconnecting the one or more modules that is configured to support one or more vessel movers thereon, the one or more vessel movers comprising a magnet and configured to receive the liquid sample, a sensor assembly configured to detect the one or more vessel movers, and a coil array associated with the track system that is configured to interact with the magnet to define a linear electromagnetic actuator and propel the vessel mover along the track system, the method comprising:
estimating, by a control system coupled to the coil array and the sensor assembly, a state of the vessel mover,
determining, by the control system, a velocity control output based on the estimated state of the vessel mover,
determining, by the control system, a position control output based on the estimated state of the vessel mover,
controlling, by the control system, movement of the vessel mover based on a fusion of the determined velocity control output and the determined position control output,
determining, by the control system, a position of the vessel mover relative to a target,
adjusting, by the control system, a relative influence of the velocity control output and the position control output on the fusion based on the relative position of the vessel mover, and
controlling, by the control system, the movement of the vessel mover based on the adjusted fusion.

12. The method of claim 11, wherein the sensor assembly comprises one or more Hall effect sensors.

13. The method of claim 11, wherein adjusting the relative influence of the estimated position and the estimated velocity comprises adjusting, by the control system, a first gain applied to the velocity control output and a second gain applied to the position control output.

14. The method of claim 11, wherein the track system comprises at least one printed circuit board (PCB) substrate.

15. The method of claim 11, wherein the state of the vessel mover comprises at least one of a position or a velocity of the vessel mover.
